(19) United States
(12) Patent Application Publication
(10) Pub. No.: US 2025/0052365 A1
(43) Pub. Date: Feb. 13, 2025

(54) Connector Fixture and Connector Detection System

(71) Applicant: Tyco Electronics (Shanghai) Co., Ltd., Shanghai (CN)

(72) Inventors: Lijiong Zhang, Shanghai (CN); Jianguo (Thomas) Yang, Shanghai (CN); Chunlong Li, Shanghai (CN)

(73) Assignee: Tyco Electronics (Shanghai) Co., Ltd., Shanghai (CN)

(21) Appl. No.: 18/796,572

(22) Filed: Aug. 7, 2024

(30) Foreign Application Priority Data
Aug. 9, 2023 (CN) 202311001514.4

(51) Int. Cl. F16M 13/02; G01B 11/22; G01B 11/26; G06T 7/00; G06T 7/55; G06T 7/70

(52) U.S. Cl. CPC F16M 13/022; G01B 11/22; G01B 11/26; G06T 7/0002; G06T 7/55; G06T 7/70; G06T 2207/30244

(57) ABSTRACT

A connector fixture includes a fixed seat, a rotating shaft passing through and rotatably installed on the fixed seat, an installation block fixed to the rotating shaft and having radial sliding slots, clamping jaws slidably installed in the radial sliding slots, a transmission component sleeved on and movable with respect to the rotating shaft, and a driving member sleeved on and driving the transmission component. The transmission component has an installation hole with grooves. An end of the rotating shaft is inserted into the installation hole and the clamping jaws are in the grooves. A first inclined plane is formed on the clamping jaws and a second inclined plane is formed on the grooves. The second inclined plate is mated with the first inclined plane to convert an axial movement of the transmission component into a radial movement of the clamping jaws to clamp a connector with the clamping jaws.

### CROSS-REFERENCE TO RELATED APPLICATION

This application claims the benefit of the filing date under 35 U.S.C. § 119 (a)-(d) of Chinese Patent Application No. 202311001514.4, filed on Aug. 9, 2023.

### FIELD OF THE INVENTION

The present invention relates to a connector fixture and a connector detection system comprising the connector fixture.

### BACKGROUND OF THE INVENTION

In order to detect an insertion depth of connector terminals, an observation window is usually formed on a connector housing, through which a camera can capture the terminals located inside the housing, and thus can calculate the insertion depth of the terminals based on the captured terminal images. To ensure that the connector remains stationary during shooting, it is necessary to clamp the connector onto a connector fixture and ensure that the observation window on the connector faces the camera.

It is common to manually place and control the placement angle of the connector so that the observation window on the connector faces the camera. Due to the small size of the connector, it is very difficult to manually position the angle of the connector, resulting in the camera often not being able to capture the terminals. Multiple attempts are needed to repeatedly adjust the placement angle of the connector, which seriously reduces detection efficiency and quality.

### SUMMARY OF THE INVENTION

A connector fixture includes a fixed seat, a rotating shaft passing through and rotatably installed on the fixed seat, an installation block fixed to the rotating shaft and having radial sliding slots, clamping jaws slidably installed in the radial sliding slots, a transmission component sleeved on and movable with respect to the rotating shaft, and a driving member sleeved on and driving the transmission component. The transmission component has an installation hole with grooves. An end of the rotating shaft is inserted into the installation hole and the clamping jaws are in the grooves. A first inclined plane is formed on the clamping jaws and a second inclined plane is formed on the grooves. The second inclined plate is mated with the first inclined plane to convert an axial movement of the transmission component into a radial movement of the clamping jaws to clamp a connector with the clamping jaws.

### BRIEF DESCRIPTION OF THE DRAWINGS

Features of the present invention will become more apparent by describing in detail exemplary embodiments thereof with reference to the accompanying drawings, in which:

FIG. 1 shows a perspective view of a connector fixture according to an exemplary embodiment of the present invention when viewed from one side;

FIG. 2 shows a sectional perspective view of a connector fixture according to an exemplary embodiment of the present invention;

FIG. 3 shows an exploded sectional perspective view of a connector fixture according to an exemplary embodiment of the present invention;

FIG. 4 shows a perspective view of a connector fixture according to an exemplary embodiment of the present invention when viewed from the other side;

FIG. 5 shows a perspective view of a driving device according to an exemplary embodiment of the present invention;

FIG. 6 shows a perspective view of a first camera, second camera, and connector of a connector detection system according to an exemplary embodiment of the present invention;

FIG. 7 shows an illustrative view of a second camera and connector of a connector detection system according to an exemplary embodiment of the present invention, wherein the observation window on the connector is not facing the second camera; and

FIG. 8 shows an illustrative view of a second camera and connector of a connector detection system according to an exemplary embodiment of the present invention, wherein the observation window on the connector is rotated to face the second camera.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

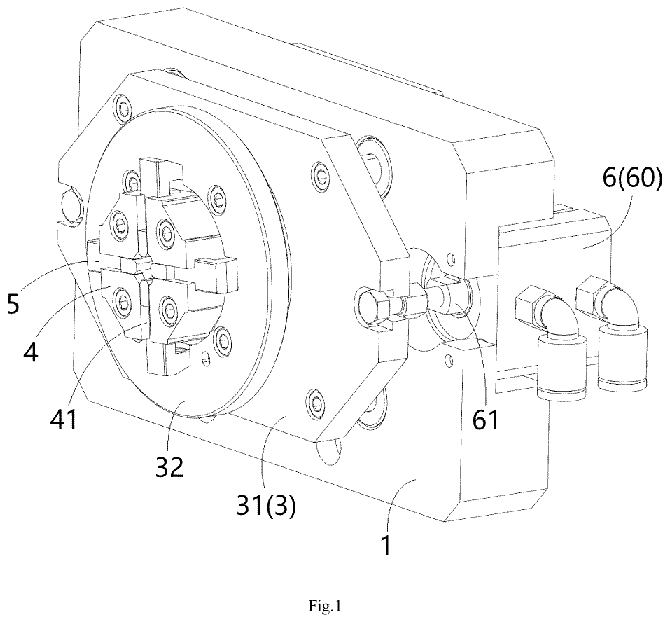

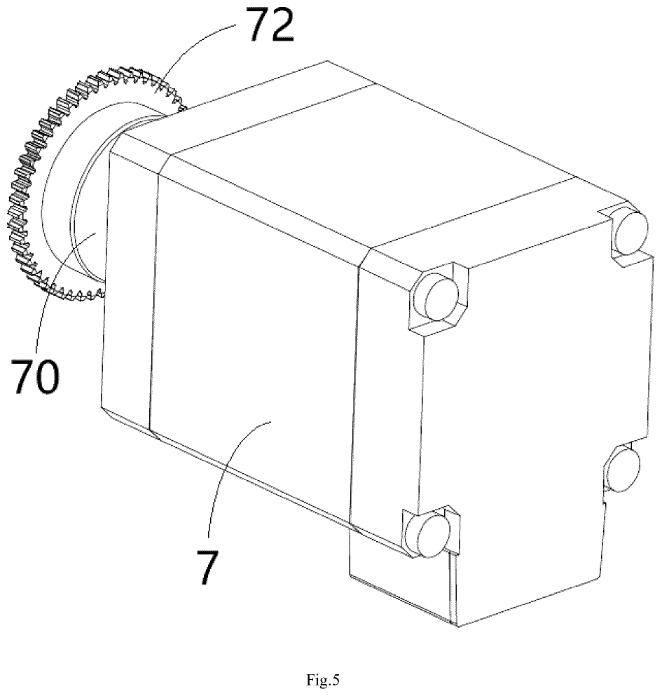

As shown in FIGS. 1 to 5, in an exemplary embodiment of the present invention, a connector fixture is disclosed. The connector fixture includes a fixed seat 1, a rotating shaft 2, a transmission component 3, an installation block 4, a plurality of clamping jaws 5, and a driving member 62.

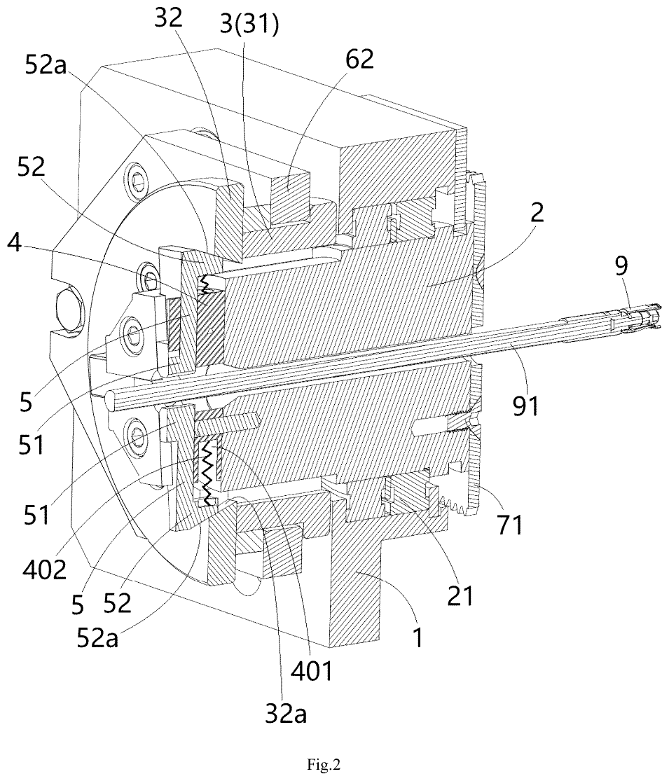

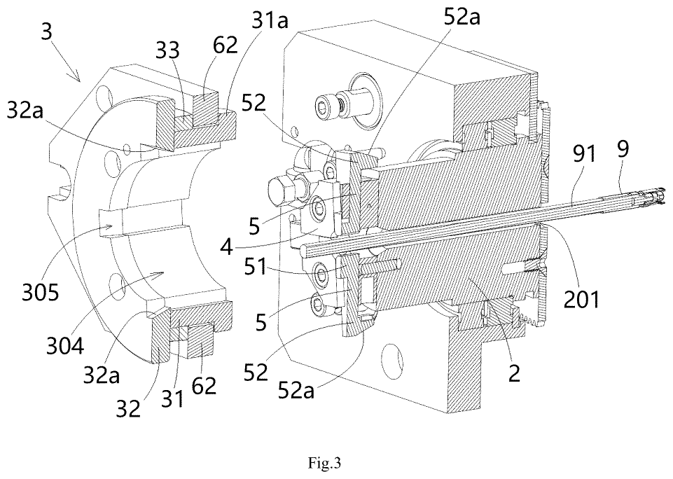

The rotating shaft 2 passes through the fixed seat 1, as shown in FIGS. 2 and 3, and is rotatably installed to the fixed seat 1. The installation block 4 is fixed to an end face of one end of the rotating shaft 2 and formed with a plurality of radial sliding slots 41, shown in FIG. 1, that are spaced in a circumferential direction. The clamping jaws 5 are respectively slidably installed in the radial sliding slots 41 on installation block 4, as shown in FIG. 1.

As shown in FIG. 2, the transmission component 3 is installed on the rotating shaft 2 and can be moved axially relative to the rotating shaft 2. The driving member 62 is installed on the transmission component 3 and is used to drive the transmission component 3 to axially move. The transmission component 3 has an installation hole 304, shown in FIG. 3, and one end of the rotating shaft 2 is inserted into the installation hole 304. A plurality of grooves 305 are formed on an inner wall surface of the installation hole 304, and first ends 52 of the clamping jaws 5 are respectively accommodated in multiple grooves 305. A first inclined plane 52a is formed on one end 52 of the clamping jaw 5, and a second inclined plane 32a is formed on the inner side of the groove 305. The second inclined plane 32a is mated with the first inclined plane 52a, in order to convert the axial movement of the transmission component 3 into the radial movement of multiple clamping jaws 5 to clamp the connector 9 by the multiple clamping jaws 5.

In the illustrated embodiments, four radial sliding slots 41 are formed on the installation block 4, and the four radial sliding slots 41 are evenly spaced in the circumferential direction, so that the four radial sliding slots 41 form a cross shape. The connector fixture comprises four clamping jaws 5, which are respectively slidably installed in four radial sliding slots 41 for radially clamping a connector 9.

As shown in FIG. 3, in the illustrated embodiments, a central through-hole 201 is formed in the rotating shaft 2 and the installation block 4 that allows a cable 91 of the connector 9 to pass through. The second ends 51 of the clamping jaws 5 surround the central through-hole 201 and are adjacent to each other, used for radially clamping the cable 91 of the connector 9.

In the shown embodiment, the transmission component 3 can be moved between a first position and a second position along the axial direction of the rotating shaft 2 under the drive of the driving member 62. When the transmission component 3 is moved to the first position, multiple clamping jaws 5 are driven to an opened position releasing the cable 91. When the transmission component 3 is moved to the second position, multiple clamping jaws 5 are driven to a clamping position clamping the cable 91.

As shown in FIG. 2, in the illustrated embodiments, the connector fixture further includes an elastic element 402, which is compressed between the clamping jaw 5 and the installation block 4 to radially push the clamping jaw 5 towards the second inclined plane 32a, so that the first inclined plane 52a and the second inclined plane 32a remain in contact with each other. The elastic element 402 can be a coil spring.

As shown in FIG. 2, in the illustrated embodiments, an installation blind hole 401 is formed in the installation block 4, and one end of the clastic element 402 is accommodated in the installation blind hole 401, while the other end of the elastic element 402 is pressed against one end 52 of the clamping jaw 5.

The transmission component 3 is rotationally connected to the driving member 62 to allow the transmission component 3 to rotate relative to the driving member 62. As shown in FIGS. 2 and 3, in the illustrated embodiments, the transmission component 3 comprises a sleeve member 31, a ring member 32, and a washer member 33. The sleeve member 31 is installed on one end of the rotating shaft 2. The ring member 32 is connected to the end face of one end of the sleeve member 31. The washer member 33 is fitted onto one end of the sleeve member 31. A limiting flange 31a is formed on the other end of the sleeve member 31, and the driving member 62 is sleeved on the sleeve member 31 and axially limited between the washer member 33 and the limiting flange 31a, and the sleeve member 31 can be rotated relative to the driving member 62.

In an embodiment, the connector fixture further comprises a driver, which is installed on the fixed seat 1 and connected to the driving member 62, for driving the driving member 62 to axially move and driving the transmission component 3 to axially move through the driving member 62.

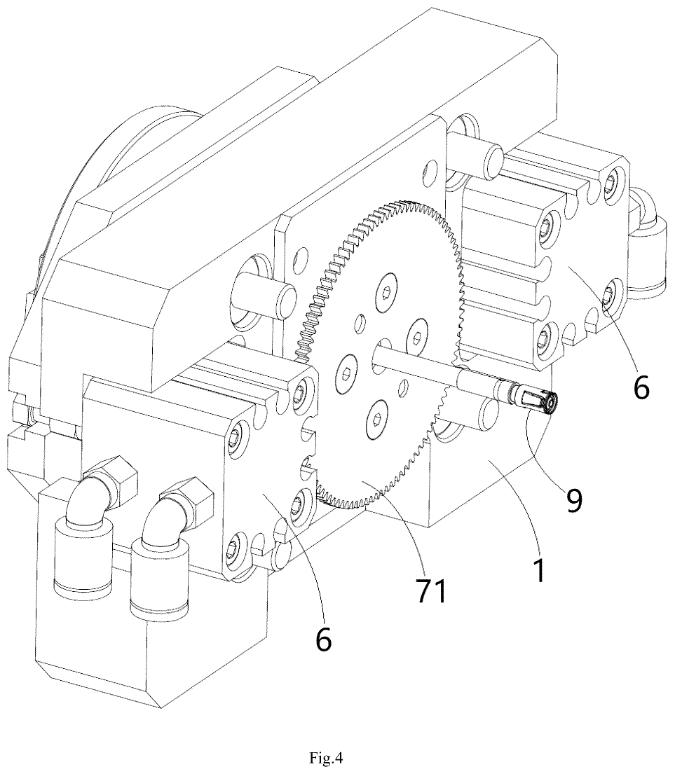

As shown in FIGS. 1 and 4, in the illustrated embodiments, the driver can be a cylinder 6, the cylinder body 60 of cylinder 6 is fixed on the fixed seat 1, and the telescopic rod 61 of cylinder 6 is connected to the driving member 62. However, the present invention is not limited to the illustrated embodiments, for example, the driver can also be a hydraulic cylinder or an electric cylinder.

The connector fixture further comprises a driving device, which is installed on the fixed seat 1 and connected to the other end of the rotating shaft 2, for driving the rotating shaft 2, the installation block 4, the clamping jaw 5, and the transmission component 3 to rotate synchronously. In this way, the clamped connector 9 can be rotated to a predetermined orientation. As shown in FIGS. 2, 4, and 5, the driving device includes a motor 7 and a transmission mechanism. The transmission mechanism is connected between the output shaft 70 of the motor 7 and the rotating shaft 2. In the illustrated embodiment, the transmission mechanism is a gear transmission mechanism. The transmission mechanism includes a first gear 71 and a second gear 72. The first gear 71 is fixed to the other end of the rotating shaft 2. The second gear 72 is fixed to the output shaft 70 of motor 7. The first gear 71 is meshed with the second gear 72.

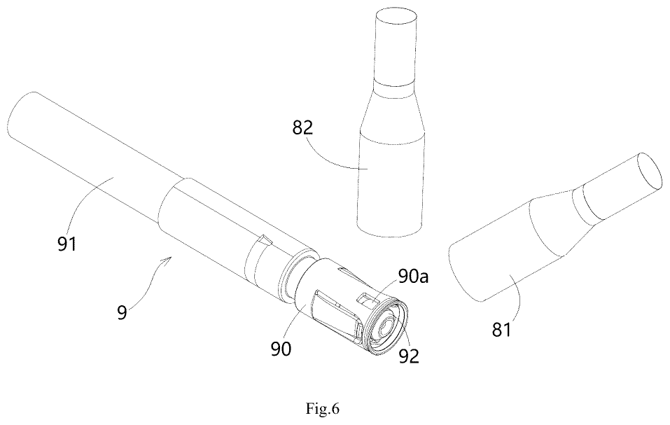

In another exemplary embodiment of the present invention, a connector detection system is also disclosed. The connector detection system includes: the aforementioned connector fixture, a first camera 81, a second camera 82, a calculation device, and a control device. The connector fixture is used to clamp the cable 91 of the detected connector 9. As shown in FIGS. 6-8, the first camera 81 is used to capture the observation window 90a on the housing 90 of the detected connector 9. The second camera 82 is used to capture the terminal 92 located inside the housing 90 through the observation window 90a.

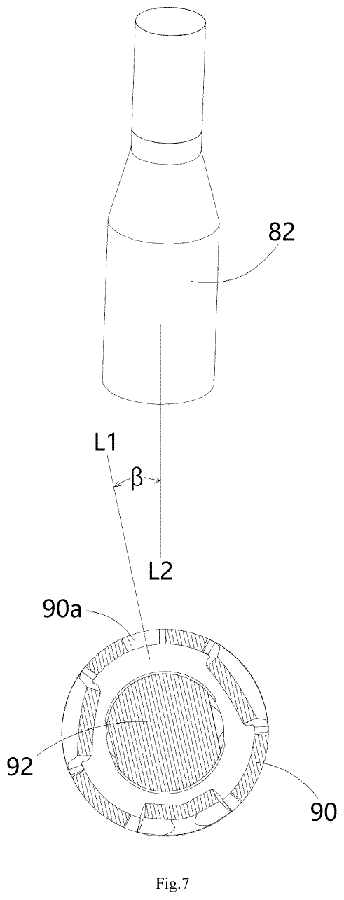

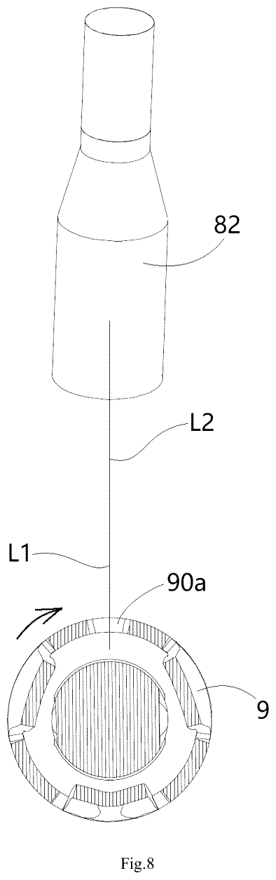

The calculation device calculates the angle β, shown in FIG. 7, between the central axis L1 of the observation window 90a and the optical axis L2 of the second camera 82 based on the image of the observation window 90a captured by the first camera 81. The control device controls the rotating shaft 2 of the connector fixture to rotate the corresponding angle β calculated by the calculation device, so that the observation window 90a is rotated to an orientation facing the second camera 82, as shown in FIG. 8. When the observation window 90a on the housing 90 of connector 9 is rotated to the orientation facing the second camera 82, the second camera 82 captures the terminal 92 through the observation window 90a.

In an embodiment, the calculation device also calculates the insertion depth of the terminal 92 inserted into the housing 90 based on the image of the terminal 92 captured by the second camera 82. When the difference between the calculated insertion depth of terminal 92 and a predetermined insertion depth is greater than a predetermined value, the connector detection system determines that the insertion depth of terminal 92 is unqualified. When the difference between the calculated insertion depth of terminal 92 and the predetermined insertion depth is not greater than the predetermined value, the connector detection system determines that the insertion depth of terminal 92 is qualified.

In the aforementioned exemplary embodiments of the present invention, the connector fixture can automatically clamp the connector 9 and accurately rotate it to a predetermined orientation, improving the detection efficiency and quality of the connector 9.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector fixture, comprising:
a fixed seat;
a rotating shaft passing through the fixed seat and rotatably installed on the fixed seat;
an installation block fixed to an end face of the rotating shaft and having a plurality of radial sliding slots spaced in a circumferential direction;
a plurality of clamping jaws slidably installed respectively in the radial sliding slots;
a transmission component sleeved on the rotating shaft and movable axially relative to the rotating shaft, the transmission component has an installation hole with a plurality of grooves on an inner wall surface of the installation hole, an end of the rotating shaft is inserted into the installation hole and a first end of each of the clamping jaws is respectively accommodated in one of the grooves; and
a driving member sleeved on the transmission component and driving the transmission component to axially move, a first inclined plane is formed on the first end of the clamping jaws and a second inclined plane is formed on each of the grooves, the second inclined plate is mated with the first inclined plane to convert an axial movement of the transmission component into a radial movement of the clamping jaws to clamp a connector with the clamping jaws.

2. The connector fixture of claim 1, wherein the radial sliding slots include four radial sliding slots formed on the installation block, the four radial sliding slots are evenly spaced in the circumferential direction and are in a cross shape, the clamping jaws include four clamping jaws that are respectively slidably installed in the four radial sliding slots for radially clamping the connector.

3. The connector fixture of claim 1, wherein a central through-hole is formed in the rotating shaft and the installation block, a cable connected to the connector extends through the central through-hole.

4. The connector fixture of claim 3, wherein a plurality of second ends of the clamping jaws surround the central through-hole and are adjacent to each other to radially clamp the cable.

5. The connector fixture of claim 4, wherein the transmission component can be moved between a first position and a second position along an axial direction of the rotating shaft while driven by the driving member.

6. The connector fixture of claim 5, wherein the clamping jaws are driven to an open position releasing the cable when the transmission component is moved to the first position and are driven to a clamping position clamping the cable when the transmission component is moved to the second position.

7. The connector fixture of claim 6, further comprising an elastic element compressed between the clamping jaws and the installation block, the elastic element radially pushing the clamping jaws toward the second inclined plane so that the first inclined plane and the second inclined plane remain in contact with each other.

8. The connector fixture of claim 7, wherein the installation block has a blind hole, a first end of the elastic element is disposed in the blind hole and a second end of the elastic element is pressed against the first end of the clamping jaw.

9. The connector fixture of claim 5, wherein the transmission component is rotationally connected to the driving member to allow the transmission component to rotate relative to the driving member.

10. The connector fixture of claim 9, wherein the transmission component includes a sleeve member fitted onto the end of the rotating shaft, a ring member connected to an end face of the sleeve member, and a washer member fitted onto a first end of the sleeve member.

11. The connector fixture of claim 10, wherein a second end of the sleeve member has a limiting flange, the driving member is sleeved on the sleeve member and axially limited between the washer member and the limiting flange, the sleeve member can be rotated relative to the driving member.

12. The connector fixture of claim 1, further comprising a driver installed on the fixed seat and connected to the driving member, the driver driving the driving member to axially move and driving the transmission component to axially move through the driving member.

13. The connector fixture of claim 12, wherein the driver is a cylinder, a cylinder body of the cylinder is fixed on the fixed seat, a telescopic rod of the cylinder is connected to the driving member.

14. The connector fixture of claim 1, further comprising a driving device installed on the fixed seat and connected to another end of the rotating shaft, the driving device drives the rotating shaft, the installation block, the clamping jaws, and the transmission component to rotate synchronously.

15. The connector fixture of claim 14, wherein the driving device includes a motor and a transmission mechanism connected between the rotating shaft and an output shaft of the motor.

16. The connector fixture of claim 15, wherein the transmission mechanism is a gear transmission mechanism including a first gear fixed to the another end of the rotating shaft and a second gear fixed to the output shaft of the motor, the first gear is meshed with the second gear.

17. A connector detection system, comprising:
a connector fixture including:
a fixed seat;
a rotating shaft passing through the fixed seat and rotatably installed on the fixed seat;
an installation block fixed to an end face of the rotating shaft and having a plurality of radial sliding slots spaced in a circumferential direction;
a plurality of clamping jaws slidably installed respectively in the radial sliding slots;
a transmission component sleeved on the rotating shaft and movable axially relative to the rotating shaft, the transmission component has an installation hole with a plurality of grooves on an inner wall surface of the installation hole, an end of the rotating shaft is inserted into the installation hole and a first end of each of the clamping jaws is respectively accommodated in one of the grooves; and
a driving member sleeved on the transmission component and driving the transmission component to axially move, a first inclined plane is formed on the first end of the clamping jaws and a second inclined plane is formed on each of the grooves, the second inclined plate is mated with the first inclined plane to convert an axial movement of the transmission component into a radial movement of the clamping jaws to clamp a connector with the clamping jaws;
a first camera capturing an observation window on a housing of the connector;
a second camera capturing a terminal located inside the housing through the observation window;
a calculation device calculating an angle between a central axis of the observation window and an optical axis of the second camera based on an image of the observation window captured by the first camera; and
a control device controlling the rotating shaft of the connector fixture to rotate the angle calculated by the calculation device, so that the observation window is rotated to an orientation directly facing the second camera, and when the observation window on the housing is rotated to the orientation directly facing the second camera, the second camera captures the terminal through the observation window.

18. The connector detection system of claim 17, wherein the calculation device calculates an insertion depth of the terminal inserted into the housing based on the image captured by the second camera.

19. The connector detection system of claim 18, wherein, when a difference between the calculated insertion depth of the terminal and a predetermined insertion depth is greater than a predetermined value, the connector detection system determines that the insertion depth of terminal is unqualified.

20. The connector detection system of claim 19, wherein, when the difference between the calculated insertion depth of the terminal and the predetermined insertion depth is not greater than the predetermined value, the connector detection system determines that the insertion depth of terminal is qualified.
